(19) United States
(12) Patent Application Publication
(10) Pub. No.: US 2026/0149231 A1
(43) Pub. Date: May 28, 2026

(54) CLAMP DEVICE

(71) Applicant: MING HSI INDUSTRY CO., LTD., Taichung City (TW)

(72) Inventor: CHIN-CHUAN CHANG, Taichung City (TW)

(21) Appl. No.: 18/962,554

(22) Filed: Nov. 27, 2024

(51) Int. Cl. H01R 43/042

(52) U.S. Cl. CPC H01R 43/042

(57) ABSTRACT

A clamp device is provided, wherein the clamp device includes: a base body including a base portion and clamping units, the clamping units being arranged linearly on the base portion, each clamping unit including two clamping members disposed on the base portion and movable between first and second states, each clamping member including a clamping portion; and at least one jaw module assembled to one clamping unit and including two press members, each press member including first and second connection portions; wherein when the two clamping members clamp the two press members, the clamping portions of the two clamping members engage with the first connection portions of the two press members, and the two clamping members are in the first state, and when the two clamping members do not clamp the two press members, the two clamping members are in the second state.

### BACKGROUND OF THE INVENTION

### Field of the Invention

The present invention relates to a hand tool, particularly to a clamp device.

### Description of the Prior Art

A crimping tool, also known as a compression plier or a crimping plier, is a specialized tool used for crimping wires and connectors, commonly employed in the fields of electronics, electrical and/or communications. A conventional crimping tool includes handles, a clamp head and crimping dies. The clamp head opens and closes under the operation of the handles. The crimping dies are disposed on the clamp head and have corresponding die openings depending on the type of connector to be clamped. Such crimping tools are disclosed in TW I836981, M604262 and M549988.

A conventional crimping tool uses a pin to position the crimping dies on the clamp head, making the process of changing the crimping dies rather inconvenient since the pin needs to be removed to replace the die. Although the aforementioned patents have made improvements in this regard by allowing the user to release the crimping dies simply by pressing, the process of changing the crimping dies remains cumbersome, not simple and not quick.

The present invention is, therefore, arisen to obviate or at least mitigate the above-mentioned disadvantages.

### SUMMARY OF THE INVENTION

The main object of the present invention is to provide a clamp device, wherein at least one jaw module can be quickly and easily transferred and exchanged.

To achieve the above and other objects, a clamp device is provided, wherein the clamp device includes: a base body including a base portion and a plurality of clamping units, the plurality of clamping units being arranged linearly on the base portion, each of the plurality of clamping units including two clamping members, the two clamping members being disposed on the base portion and movable between a first state and a second state, each of the plurality of clamping members including a clamping portion; and at least one jaw module assembled to one of the plurality of clamping units and including two press members, each of the two press members including a first connection portion and a second connection portion; wherein when the two clamping members clamp the two press members, the clamping portions of the two clamping members engage with the first connection portions of the two press members, and the two clamping members are in the first state, and when the two clamping members do not clamp the two press members, the two clamping members are in the second state.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of an exemplary embodiment of the present invention;

FIG. 2 is a schematic view showing the combination of a clamp body and a base body according to an exemplary embodiment of the present invention;

FIG. 3 is a schematic view showing the engagement of a projection of an operation member in an engaging slot of a grip portion according to an exemplary embodiment of the present invention;

FIG. 4 is a partial cross-sectional view of a clamp body without a jaw module assembled according to an exemplary embodiment of the present invention;

FIG. 5 is a schematic view of a stop portion in FIG. 4 moving to a stop position;

FIGS. 6 to 8 show schematic views of the operation of the clamp body inserting in a jaw module of the clamping unit according to an exemplary embodiment of the present invention; and

FIG. 9 is a schematic view of the clamp body being transferred to the jaw module of the clamping unit according to an exemplary embodiment of the present invention.

### DETAILED DESCRIPTION OF THE PREFERRED EMBODIMENTS

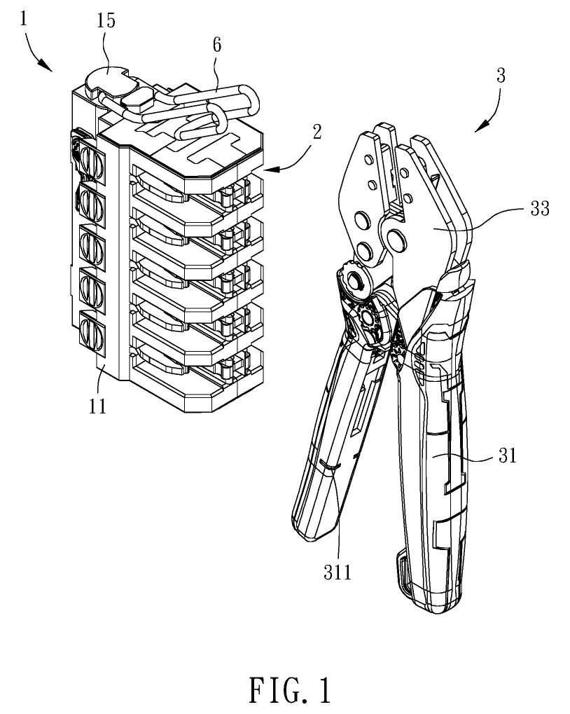

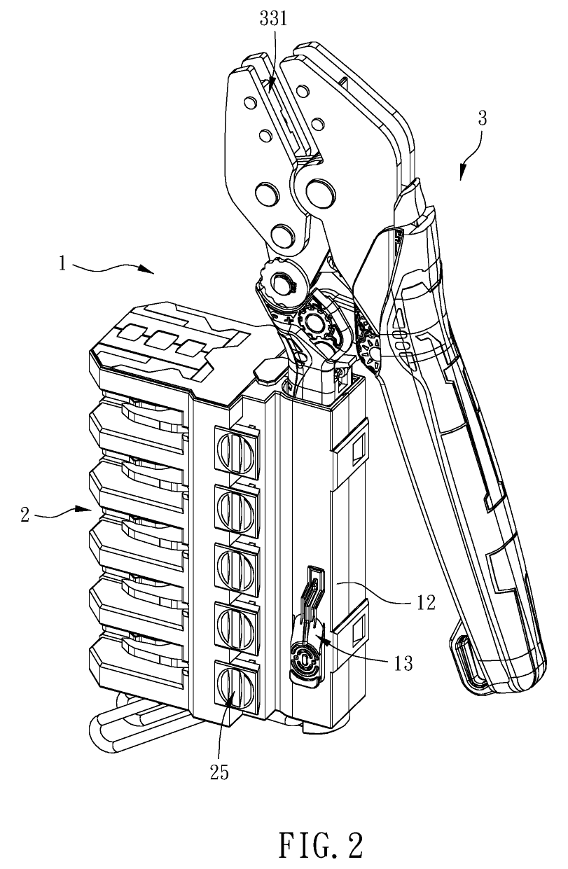

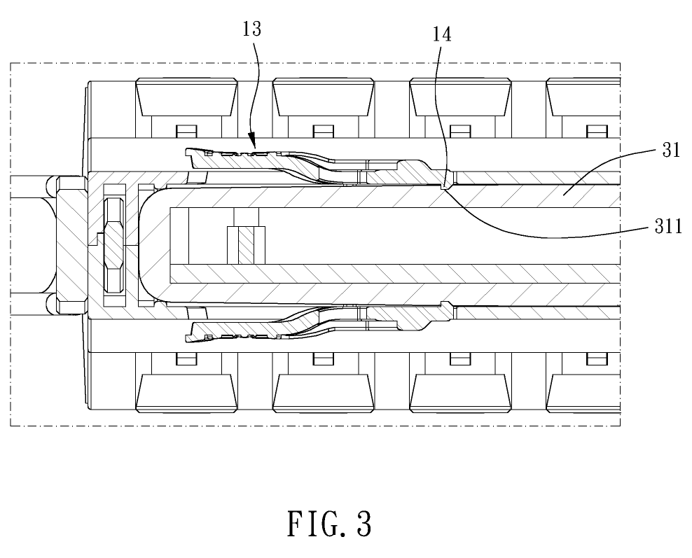

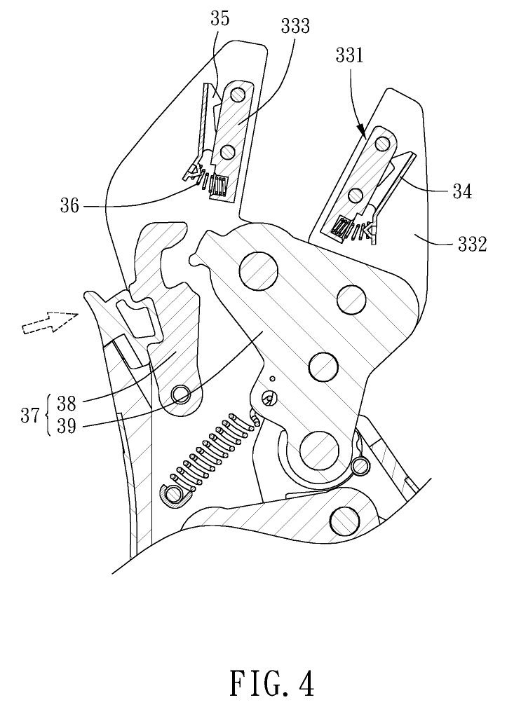

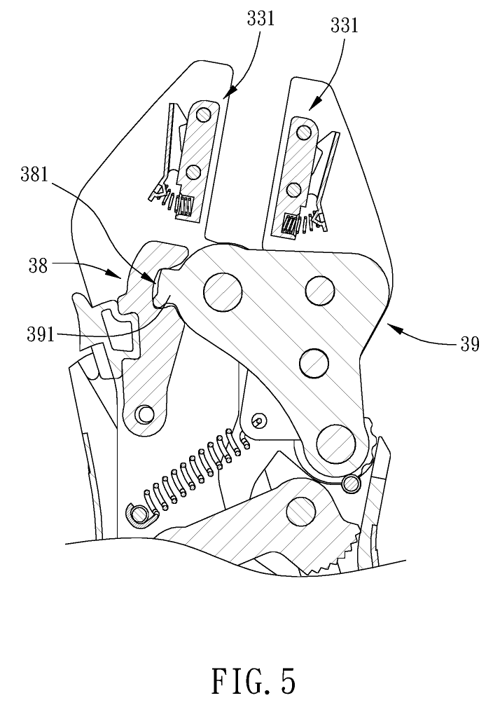

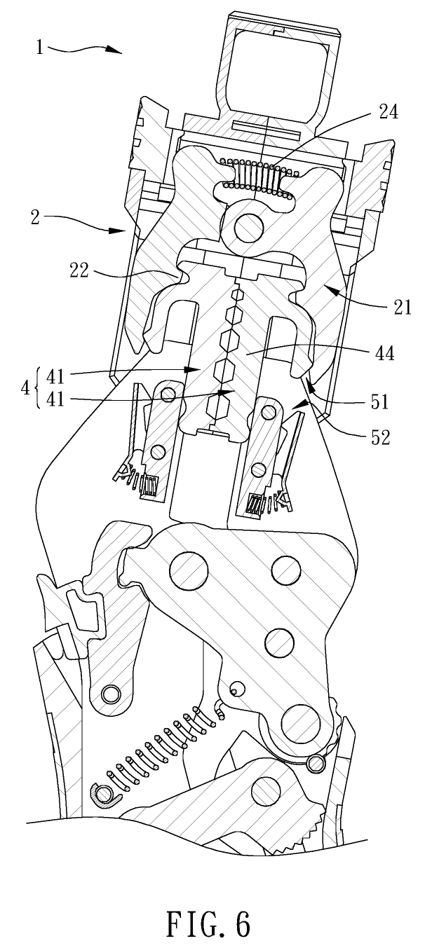

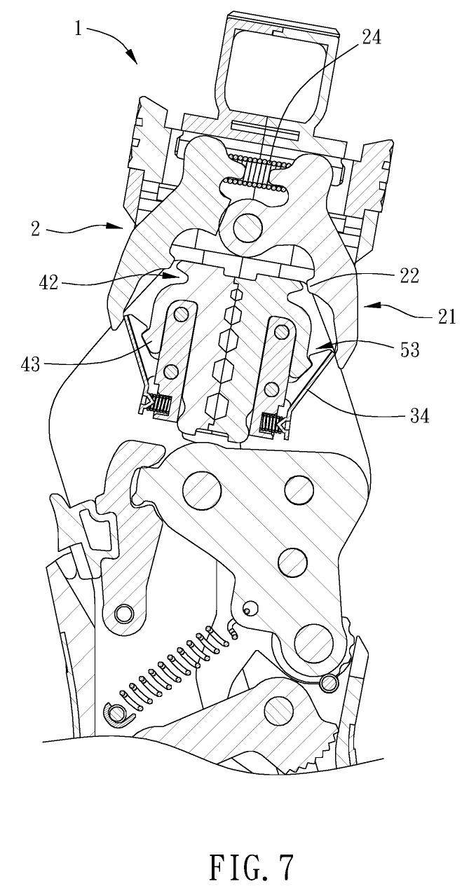

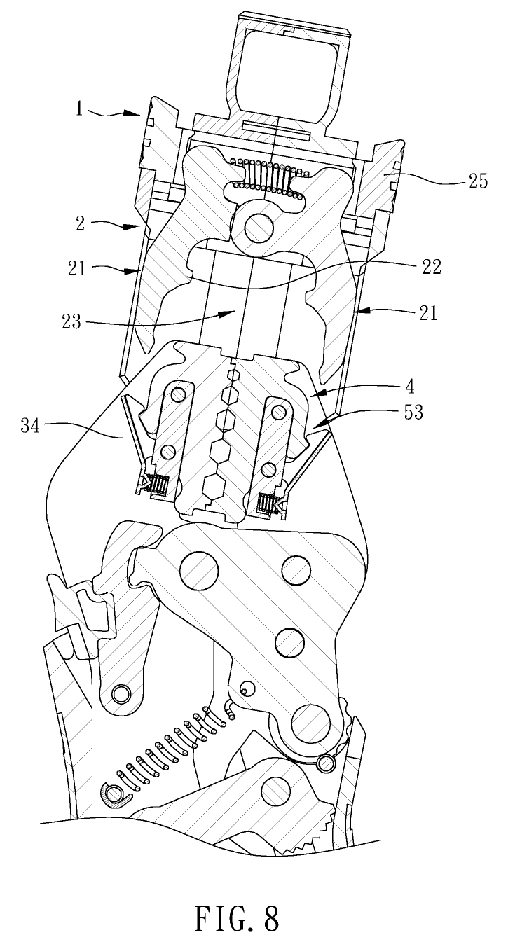

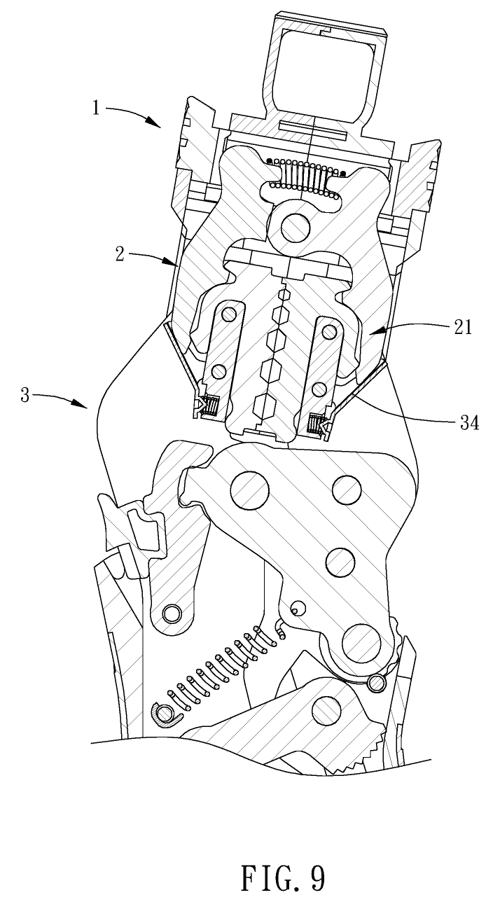

Please refer to FIGS. 1 to 9 for an exemplary embodiment of the present invention. A clamp device of the present invention includes a base body 1, a clamp body 3, and at least one jaw module 4.

The base body 1 includes a base portion 11 and a plurality of clamping units 2. The plurality of clamping units 2 are arranged linearly on the base portion 11 to facilitate operation and viewing, and occupying less spatial volume. Each of the plurality of clamping units 2 includes two clamping members 21. The two clamping members 21 are movable between a first state and a second state relative to the base portion 11, and each of the plurality of clamping members 21 includes a clamping portion 22.

The clamp body 3 includes two grip portions 31, two working heads 33, and two positioning members 34. The two grip portions 31 are movably connected to each other, and the two working heads 33 are respectively arranged on the two grip portions 31, allowing them to open and close relative to each other. The two positioning members 34 are movable between a locking state and a releasing state and are respectively arranged on the two working heads 33. Each of the two positioning members 34 includes a positioning portion 35.

The at least one jaw module 4 can be transferred between the clamping unit 2 and the clamp body 3. The at least one jaw module 4 includes two press members 41, and each of the two press members 41 includes a first connection portion 42 and a second connection portion 43. The first connection portion 42 can selectively engage with the clamping portion 22, and the second connection portion 43 can selectively hook with the positioning portion 35. The clamp body 3 can be assembled with the at least one jaw module 4. When the two clamping members 21 clamp the two press members 41, the clamping portions 22 of the two clamping members 21 engage with the first connection portions 42 of the two press members 41, and the two clamping members 21 are in the first state. When the two clamping members 21 do not clamp the two press members 41, the two clamping members 21 are in the second state. When the two positioning members 34 clamp the two press members 41, the positioning portions 35 of the two positioning members 34 engage with the second connection portions 43 of the two press members 41, and the two positioning members 34 are in the locking state. When the two positioning members 34 do not clamp the two press members 41, the two positioning members 34 are in the releasing state.

Preferably, the at least one jaw module includes a plurality of jaw modules 4, and the plurality of jaw modules 4 are disposed on the plurality of clamping units 2, respectively, with different configurations to allow the user to select the required jaw module 4 according to the situation.

When the at least one jaw module 4 is to be transferred from the base body 1 to the clamp body 3, the two positioning members 34 in the releasing state can be inserted in an insertion direction between the two clamping members 21 in the first state, causing the clamping portions 22 of the two clamping members 21 to disengage from the first connection portions 42 of the two press members 41, thereby releasing the at least one jaw module 4. At the same time, the two positioning members 34 move to the locking state to engage with the at least one jaw module 4, and the at least one jaw module 4 can be withdrawn from the two clamping members 21.

When the at least one jaw module 4 is to be transferred from the clamp body 3 to the base body 1, the two clamping members 21 in the second state can be inserted in reverse in the insertion direction between the two positioning members 34 in the locking state, causing the positioning portions 35 of the two positioning members 34 to disengage from the second connection portions 43 of the two press members 41, thereby releasing the at least one jaw module 4. At the same time, the two clamping members 21 move to the first state to engage with the at least one jaw module 4, and the at least one jaw module 4 can be withdrawn from the two positioning members 34.

Preferably, each of the plurality of clamping units 2 further includes a first elastic member 24, and the first elastic member 24 is elastically positioned between the two clamping members 21 to urge the clamping portions 22 of the two clamping members 21 toward each other. When the at least one jaw module 4 enters between the two clamping members 21, the clamping portions 22 automatically engage. Similarly, the clamp body 3 preferably includes a second elastic member 36, and the second elastic member 36 is elastically positioned between the two positioning members 34 to urge the positioning portions 35 toward each other, so that when the at least one jaw module 4 enters between the two positioning members 34, it is automatically positioned. Therefore, when either the clamp body 3 or the clamping unit 2 releases the at least one jaw module 4, the other will automatically clamp the at least one jaw module 4. The user only needs to hold the clamp body 3, insert the two working heads 33 in the insertion direction into the clamping unit 2, and the at least one jaw module 4 will be transferred from the base body 1 to the clamp body 3. Repeating the same operation allows the at least one jaw module 4 to be transferred again, such as from the clamp body 3 back to the base body1, providing a highly convenient and rapid operation for the user.

Specifically, each of the two clamping members 21 is swingably disposed on the base portion 11, and each of the two positioning members 34 is swingably disposed on one of the two working heads 33. When the at least one jaw module 4 is positioned to the base body 1, the two clamping members 21 and the two press members 41 form two first insertion slots 51, and each of the plurality of clamping members 21 and one of the press members 41 together forming one of the first insertion slots 51. At the same time, the two positioning members 34 and the insertion portions 333 of the two working heads 33 form two second insertion slots 52, and each of the two positioning members 34 and one of the insertion portions 333 of the two working heads 33 forming one of the second insertion slots 52. When the at least one jaw module 4 is to be transferred from the base body 1 to the clamp body 3, the two positioning members 34, which are in the releasing state, are inserted in the two first insertion slots 51, and portions of the two press members 41 are reversely inserted in the two second insertion slots 52. During the transfer process, the portions of the two press members 41 push apart the two positioning members 34 in a direction perpendicular to the insertion direction, indirectly driving the two clamping members 21 to move until the clamping portions 22 of the two clamping members 21 disengage from the first connection portions 42 of the two press members 41, and the positioning portions 35 of the two positioning members 34 engage with the second connection portions 43 of the two press members 41, thereby completing the transfer and assembly of the at least one jaw module 4.

Specifically, when the at least one jaw module 4 is positioned to the clamp body 3, a clamp opening 23 is formed between the two clamping members 21. At this time, the two positioning members 34 and the two press members 41 form two third insertion slots 53, and each of the two positioning members 34 and one of the press members 41 form one of the third insertion slots 53. When the at least one jaw module 4 is to be transferred from the clamp body 3 to the base body 1, the two clamping members 21, which are in the second state, can be inserted in the two third insertion slots 53, and the portions of the two press members 41 are inserted in the clamp opening 23, thereby pushing apart the two positioning members 34 until the positioning portions 35 of the two positioning members 34 disengage from the second connection portions 43 of the two press members 41, and the clamping portions 22 of the two clamping members 21 engage with the first connection portions 42 of the two press members 41, thereby completing the transfer and assembly of the at least one jaw module 4.

Preferably, each of the plurality of clamping units 2 further includes two release members 25. The two release members 25 are movably disposed on the base portion 11 and located on opposite ends of the clamping portions 22 of the two clamping members 21. The two release members 25 are externally operable to force the clamping portions 22 of the two clamping members 21 to move away from each other, allowing the user to easily remove or replace the at least one jaw module 4 with a different configuration by hand.

Each of the two press members 41 includes an engaging portion 44. Each working head 33 includes an assembling slot 331 and a main body 332, and the assembling slot 331 extends into the main body 332. The engaging portion 44 of each of the two press members 41 is slidably engaged with the assembling slot 331. The clamp body 3 further includes a restriction mechanism 37, and the restriction mechanism includes a stop portion 38 and an abutting portion 39. The stop portion 38 is movably arranged in a stop position on the main body 332 of one of the two working heads 33, and the abutting portion 39 is disposed on the main body 332 of the other of the two working heads 33. The stop portion 38 and the abutting portion 39 are movable with the two working heads 33. When the stop portion 38 moves to the stop position, the stop portion 38 is located in the movement path of the abutting portion 39. At this time, the stop portion 38 and the abutting portion 39 abut each other at a predetermined position, aligning the positions of the assembling slots 331 on the two working heads 33 with the engaging portions 44 of the two press members 41 on the base body 1. In other words, the user only needs to bring the two working heads 33 closer together to align them optimally, enabling an easy and efficient transfer of the at least one jaw module 4.

In this embodiment, the stop portion 38 includes a receiving slot 381 on a side facing the abutting portion 39, and the abutting portion 39 includes an engaging block 391 protruding toward the stop portion 38. When the stop portion 38 moves to the stop position, the receiving slot 381 is aligned with the movement path of the engaging block 391. As the abutting portion 39 swings to the predetermined position, the engaging block 391 is inserted in the receiving slot 381.

Preferably, the base body 1 further includes an assembling portion 12. One of the two grip portions 31 is detachably inserted in the assembling portion 12, allowing the clamp body 3 to be securely assembled to the base body 1 for storage when not in use or during transportation.

In an alternative embodiment, at least one of the two grip portions 31 includes at least one engaging slot 311. The base body 1 further includes at least one operation member 13. A middle section of the operation member 13 is positioned to the assembling portion 12, and two opposite ends of the operation member 13 are free ends so that the at least one operation member 13 can act like a seesaw relative to the assembling portion 12. One of the two opposite ends of the at least one operation member 13 includes a projection 14, and the other of the two opposite ends of the at least one operation member 13 is configured for external pressing. The projection 14 of the at least one operation member 13 can be inserted in the assembling portion 12 to engage with at least one engaging slot 311, enhancing the stability of the connection between the clamp body 3 and the base body 1. In this embodiment, the at least one operation member includes two operation members 13, and the two operation members 13 are integrally formed on the base portion 11.

In yet another preferable embodiment, the clamp device further includes a hanging member 6. The hanging member 6 is connected to the base body 1, allowing the clamp device to be hung on the user’s belt or tool belt, freeing the user's hands when the clamp device is not in use. In this embodiment, the base body 1 further includes a metal member 15 which is positioned to the base portion 11. The hanging member 6 is disposed on the metal member 15. The metal member 15 has a more strong structure, capable of withstanding greater force, making it more durable. The metal member 15 is positioned to a side of the assembling portion opposite to an opening of the assembling portion 12.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A clamp device including:
a base body including a base portion and a plurality of clamping units, the plurality of clamping units being arranged linearly on the base portion, each of the plurality of clamping units including two clamping members, the two clamping members being disposed on the base portion and movable between a first state and a second state, each of the plurality of clamping members including a clamping portion; and
at least one jaw module assembled to one of the plurality of clamping units and including two press members, each of the two press members including a first connection portion and a second connection portion;
wherein when the two clamping members clamp the two press members, the clamping portions of the two clamping members engage with the first connection portions of the two press members, and the two clamping members are in the first state, and when the two clamping members do not clamp the two press members, the two clamping members are in the second state.

2. The clamp device of claim 1, further including a clamp body, wherein the at least one jaw module is replaceably assembled to either the clamping unit or the clamp body, the clamp body includes two grip portions, two working heads and two positioning members, the two grip portions are movably connected to each other, the two working heads are respectively arranged on the two grip portions and movable relative to each other, the two positioning members are arranged on the two working heads and movable between a locking state and a releasing state, each of the two positioning members includes a positioning portion, the clamp body and the at least one jaw module are detachably assembled to each other, when the two positioning members clamp the two press members, the positioning portions of the two positioning members engage with the second connection portions of the two press members, and the two positioning members are in the locking state, and when the two positioning members do not clamp the two press members, the two positioning members are in the releasing state.

3. The clamp device of claim 1, wherein each of the plurality of clamping units further includes a first elastic member, and the first elastic member is elastically positioned between the two clamping members and urges the clamping portions of the two clamping members toward each other.

4. The clamp device of claim 2, wherein the clamp body further includes a second elastic member, and the second elastic member is elastically positioned between the two positioning members and urges the positioning portions of the two positioning members toward each other.

5. The clamp device of claim 2, wherein each of the plurality of clamping members is swingably disposed on the base portion, each of the two positioning members is swingably disposed on one of the two working heads, when the at least one jaw module is assembled to the base body, the two clamping members and the two press members form two first insertion slots, each of the two clamping members and each of the two press members form one of the first insertion slots, the two positioning members and the insertion portions of the two working heads form two second insertion slots, each of the two positioning members and the insertion portion of one of the two working heads form one of the two second insertion slots, and when the at least one jaw module is to be transferred from the base body to the clamp body, the two positioning members in the releasing state are inserted in the two first insertion slots, and simultaneously, portions of the two press members are inserted in reverse in the two second insertion slots, during the transfer process, the portions of the two press members push apart the two positioning members to indirectly drive the two clamping members to move until the clamping portions of the two clamping members disengage from the first connection portions of the two press members, and the positioning portions of the two positioning members engage with the second connection portions of the two press members.

6. The clamp device of claim 2, wherein each of the plurality of clamping members is swingably disposed on the base portion, each of the two positioning members is swingably disposed on one of the two working heads, when the at least one jaw module is assembled to the clamp body, a clamp opening is formed between the two clamping members, the two positioning members and the two press members form two third insertion slots, each of the two positioning members and one of the two press members form one of the two third insertion slots, and when the at least one jaw module is to be transferred from the clamp body to the base body, the two clamping members in the second state can be inserted in the two third insertion slots, portions of the two press members are inserted in the clamp opening to drive the two clamping members to push apart the two positioning members until the positioning portions of the two positioning members disengage from the second connection portions of the two press members, and the clamping portions of the two clamping members engage with the first connection portions of the two press members.

7. The clamp device of claim 2, wherein the base body further includes an assembling portion, and one of the two grip portions is detachably inserted in the assembling portion.

8. The clamp device of claim 7, wherein at least one of the two grip portions includes at least one engaging slot, the base body further includes at least one operation member, a middle section of the at least one operation member is positioned to the assembling portion, two opposite ends of the at least one operation member are free ends so that the at least one operation member can act as a seesaw relative to the assembling portion, one of the two opposite ends of the at least one operation member includes a projection, the other of the two opposite ends of the at least one operation member is configured for external pressing, the projection of the at least one operation member can be inserted in the assembling portion to engage with the at least one engaging slot.

9. The clamp device of claim 2, wherein each of the two press members includes an engaging portion, each of the two working heads includes an assembling slot and a main body, the assembling slot is disposed in the main body, the engaging portion is slidably engage with the assembling slot, the clamp body further includes a restriction mechanism, the restriction mechanism includes a stop portion and an abutting portion, the stop portion is movably arranged in a stop position on the main body of one of the two working heads, the abutting portion is disposed on the main body of the other of the two working heads, the stop portion and the abutting portion are movable with the two working heads, and when the stop portion moves to the stop position, the stop portion is located in a movement path of the abutting portion, and the stop portion and the abutting portion abut each other at a predetermined position so that positions of the assembling slots on the two working heads cooperate with positions of the engaging portions on the two press members installed on the base body.

10. The clamp device of claim 2, wherein each of the plurality of clamping units further includes a first elastic member, and the first elastic member is elastically positioned between the two clamping members and urges the clamping portions of the two clamping members toward each other; the clamp body further includes a second elastic member, the second elastic member is elastically positioned between the two positioning members and urges the positioning portions of the two positioning members toward each other; each of the plurality of clamping members is swingably disposed on the base portion, each of the two positioning members is swingably disposed on one of the two working heads, when the at least one jaw module is assembled to the base body, the two clamping members and the two press members form two first insertion slots, each of the two clamping members and each of the two press members form one of the first insertion slots, the two positioning members and the insertion portions of the two working heads form two second insertion slots, each of the two positioning members and the insertion portion of one of the two working heads form one of the two second insertion slots, and when the at least one jaw module is to be transferred from the base body to the clamp body, the two positioning members in the releasing state are inserted in the two first insertion slots, and simultaneously, portions of the two press members are inserted in reverse in the two second insertion slots, during the transfer process, the portions of the two press members push apart the two positioning members to indirectly drive the two clamping members to move until the clamping portions of the two clamping members disengage from the first connection portions of the two press members, and the positioning portions of the two positioning members engage with the second connection portions of the two press members; when the at least one jaw module is assembled to the clamp body, a clamp opening is formed between the two clamping members, the two positioning members and the two press members form two third insertion slots, each of the two positioning members and one of the two press members form one of the two third insertion slots, and when the at least one jaw module is to be transferred from the clamp body to the base body, the two clamping members in the second state can be inserted in the two third insertion slots, portions of the two press members are inserted in the clamp opening to drive the two clamping members to push apart the two positioning members until the positioning portions of the two positioning members disengage from the second connection portions of the two press members, and the clamping portions of the two clamping members engage with the first connection portions of the two press members; the base body further includes an assembling portion, and one of the two grip portions is detachably inserted in the assembling portion; at least one of the two grip portions includes at least one engaging slot, the base body further includes at least one operation member, a middle section of the at least one operation member is positioned to the assembling portion, two opposite ends of the at least one operation member are free ends so that the at least one operation member can act as a seesaw relative to the assembling portion, one of the two opposite ends of the at least one operation member includes a projection, the other of the two opposite ends of the at least one operation member is configured for external pressing, the projection of the at least one operation member can be inserted in the assembling portion to engage with the at least one engaging slot; each of the two press members includes an engaging portion, each of the two working heads includes an assembling slot and a main body, the assembling slot is disposed in the main body, the engaging portion is slidably engaged with the assembling slot, the clamp body further includes a restriction mechanism, the restriction mechanism includes a stop portion and an abutting portion, the stop portion is movably arranged in a stop position on the main body of one of the two working heads, the abutting portion is disposed on the main body of the other of the two working heads, the stop portion and the abutting portion are movable with the two working heads, and when the stop portion moves to the stop position, the stop portion is located in a movement path of the abutting portion, and the stop portion and the abutting portion abut each other at a predetermined position so that positions of the assembling slots on the two working heads cooperate with positions of the engaging portions on the two press members installed on the base body; the at least one operation member includes two operation members; the two operation members are integrally formed on the base portion; the base body further includes a metal member which is positioned to the base portion; the clamp device further includes a hanging member which is connected to the base body and positioned to the metal member; each of the plurality of clamping units further includes two release members which are movably disposed on the base portion and located on opposite sides of the clamping portions of the two clamping members; the two release members are externally operable to force the clamping portions of the two clamping members to move away from each other; the first connection portion is selectively engaged with the clamping portion, and the second connection portion is selectively hooked with the positioning portion; the at least one jaw module includes a plurality of jaw modules, the plurality of jaw modules are disposed on the plurality of clamping units, respectively, and the metal member is positioned to a side of the assembling portion opposite to an opening of the assembling portion.
